(19) United States
(12) Patent Application Publication
(10) Pub. No.: US 2009/0263708 A1
(43) Pub. Date: Oct. 22, 2009

(54) SYSTEM AND METHOD OF INTEGRATED THERMAL MANAGEMENT FOR A MULTI-CELL BATTERY PACK

(76) Inventors: Josh Bender, San Francisco, CA (US); Forrest North, San Francisco, CA (US); Mason Cabot, San Francisco, CA (US); Paul Durkee, San Francisco, CA (US)

Correspondence Address: SCHOX PLC, 500 3rd Street, Suite 515, San Francisco, CA, 94107, US

(21) Appl. No.: 12/417,624

(22) Filed: Apr. 2, 2009

Related U.S. Application Data
(60) Provisional application No. 61/041,848, filed on Apr. 2, 2008.
(60) Provisional application No. 61/052,913, filed on May 13, 2008.
(60) Provisional application No. 61/116,551, filed on Nov. 20, 2008.

(51) Int. Cl. H01M 10/50

(52) U.S. Cl. 429/120

(57) ABSTRACT

Disclosed is a multi-cell battery pack system that includes a plurality of cylindrical cells; a cradle with an interior surface that defines a channel extending through the length of the cradle and an exterior surface that mechanically positions each of the cells radially around and parallel to the channel and exchanges heat with the cells by extending around of the circumference of the cylindrical cell and substantially extending between the two opposing end surfaces of the cell; a heat conductor that resides at least partially within the channel and exchanges heat with the interior surface of the cradle; and a heat exchanger that exchanges heat with the heat conductor, wherein the cradle, the heat conductor, and the heat exchanger cooperate to exchange heat between the cells and the heat exchanger.

### CROSS-REFERENCE TO RELATED APPLICATIONS

This application claims the benefit of U.S. Provisional Application number filed 2008 Apr. 2, U.S. Provisional Application No. 61/052,913 filed 208 May 13, and U.S. Provisional Application No. 61/116,551 filed 208 Nov. 20, which are incorporated in their entirety by this reference.

### TECHNICAL FIELD

This invention relates generally to the battery management field, and more specifically to new and useful structure and method in the thermal and electrical battery management field.

### BACKGROUND

Within the class of mass-produced batteries, lithium ion batteries have one of the highest energy densities. These batteries, which are most commonly used in laptop computers, are the most cost-effective in a relative small form factor. To create a suitable power supply for electrical transportation needs (in, for example, passenger vehicles, all-terrain vehicles, motorcycles, and scooters) relatively large numbers of these cells (on the order of hundreds or even thousands) must be grouped together. The large number of cells require a controlled environment to function efficiently, reliably, and safely.

The lithium ion batteries are available in two general varieties: “power” and “energy”. Power cells can provide higher power bursts for shorter time durations, while energy cells can provide greater total energy, but lower power, over longer time durations. In order to combine the advantages of high power and greater total energy available, it is desirable to manipulate an energy cell to occasionally release higher power bursts. This manipulation, however, produces a large amount of heat and is best performed in optimal temperature conditions for the battery cells. Due to the specific cell chemistry of a lithium ion cell, if a substantial amount of current is pulled from the cell, and the heat is not dissipated quickly away from the cell, the cell will generate significant heat. The generated heat may shorten the working life of the cell and, under certain situations, could cause catastrophic cell failure. In addition, relatively cold temperatures (for example, winter conditions) cause the specific cell chemistry of a lithium ion cell to yield a less efficient power output.

Keeping the large number of cells within a specific operating temperature range (which conventionally requires cooling or heating) is challenging, especially when there are numerous cells in close proximity to each other. Typically, a good thermal conductor is also an electrical conductor. If this heat conductor is placed in contact with multiple cell bodies, they may be adversely electrically connected. Providing electrical connections between the cells, but a certain level of electrical and environment isolation (to improve the ability to contain heat and fire in the event of a cell catastrophic failure), is also challenging. Again, typically a good electrical conductor is also a good thermal conductor.

Thus, there is a need in the field to create a system and method of integrated thermal management for a multi-cell battery pack that facilitates the occasional release of higher power bursts from an energy cell, in an efficient, reliable, and safe manner. This invention provides such improved system and method.

### BRIEF DESCRIPTION OF THE FIGURES

FIGS. 1a and 1b are a front and cross-sectional schematic representation of the multi-cell battery system of the preferred embodiments.

FIGS. 2-3 and 5-6 are isometric views of the multi-cell battery pack system of a first preferred embodiment in various levels of construction.

FIG. 4 is a cross-sectional view of the heat pipe and heat exchanger of the system of first preferred embodiment.

FIGS. 7-8 are isometric views of the multi-cell battery pack system of a second preferred embodiment in various levels of construction.

FIG. 9 is an isometric view of the multi-cell battery pack system of a third preferred embodiment.

FIGS. 10-11 are isometric views of a several multi-cell battery pack systems of the first preferred embodiment combined to form a larger power system, in various levels of construction.

FIG. 12 is an isometric view of several multi-cell battery pack system of the second preferred embodiment combined to form a larger power system.

FIG. 13 is a cross-sectional view of several multi-cell battery pack systems of the third preferred embodiment combined to form a larger power system.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

The preferred embodiments of the invention were specifically designed to incorporate lithium ion cells of type number 18650, which have the following specification: Nominal Voltage is 3.6-3.7 V, Shape is cylindrical, Diameter is 18 mm, Length is 65 mm, and Capacity is 2400-2600 mAh. These cells, which are lightweight and have a high energy density, are generally used in laptop computers. With minimal or no modifications, the preferred embodiments may be used with cells of greater (or lower) capacities and, with only slight modifications, the preferred embodiments may be used with cells of greater (or lower) voltages. The preferred embodiments may be easily scaled to incorporate lithium ion cells of type number 26700 (which have the following specifications: Shape is cylindrical, and Diameter is 26 mm, Length is 70 mm), type number 26650, or to incorporate any suitable cells that have a cylindrical shape.

The preferred embodiments were specifically designed for lightweight, electrical transportation needs (in, for example, scooters, motorcycles, all-terrain vehicles, and small passenger vehicles) and for lightweight, electrical agriculture and construction needs (in, for example, lawnmowers and forklifts), but may be further implemented in other suitable environments and application. One such suitable application includes an embodiment to efficiently package, house, and thermally regulate solar arrays, fuel cells, or any other grouped commodity. Another such suitable application includes an embodiment to replace diesel or other fuel-fired generators, such as fixed or mobile auxiliary power units.

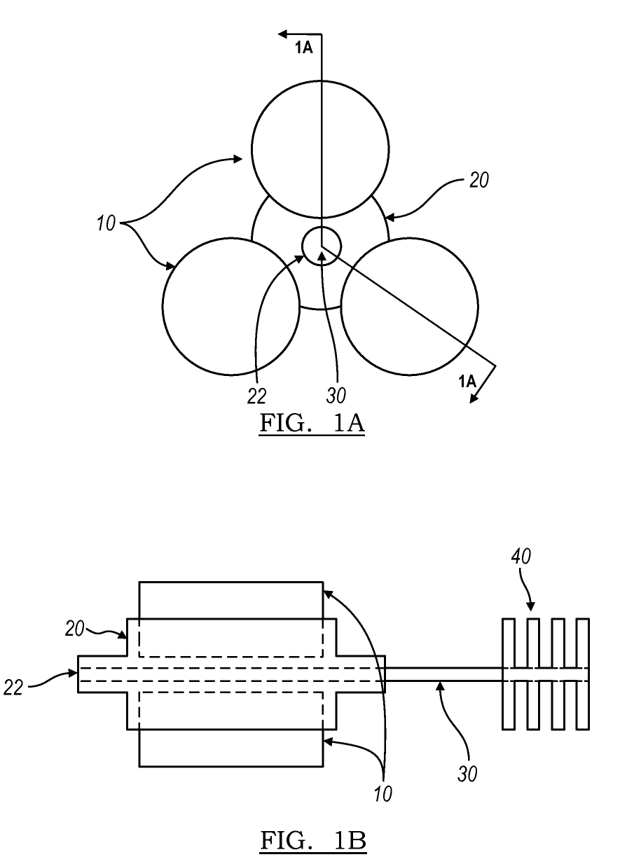

As shown in FIG. 1, the multi-cell battery pack system 100 of the preferred embodiments includes a plurality of cells 10, a cradle 20 that exchanges heat with each of the plurality of cells 10 and that defines a channel 22, a heat conductor 30 that resides at least partially within the channel 22 and exchanges heat with the cradle 20, and a heat exchanger 40 that exchanges heat with the heat conductor 30. The cradle 20 functions to mechanically position each of the plurality of cells 10 radially around the channel 22 and the heat conductor 30, preferably such that each of the plurality of cells is radially equidistant from the heat conductor 30 (or alternatively such that the plurality of cells 10 is not radially equidistant from the heat exchanger 30). The system 100 preferably functions to remove heat from the plurality of cells 10 during operation and preventing overheating that may lead to lower cell efficiency, lower life span, and higher risk of catastrophic failure. The system 100 may alternatively function to bring heat to the plurality of cells 10. Because the cells 10 generally have a temperature range of maximum operation efficiency, bringing heat to the plurality of cells 10 may provide the necessary temperature range for the cells 10 to operate efficiently in particularly cold weather conditions. However, any heat exchange suitable to thermally managing the plurality of cells may be used.

The cradle 20 of the preferred embodiments functions to cradle cells in a generally triangular shape, but may alternatively function to cradle cells in a hexagonal shape, a diamond or square shape, or any other suitable geometric shape. By stacking the cells, the cradle preferably functions to cradle a total number of six cells (with three cells on each of two “levels”), but may alternatively function to cradle any suitable number of cells (such as, for example, 2×1, 2×2, 2×3, 2×4, 3×1, 3×2, 3×3, 4×1, 4×2, 4×3, 6×1, 6×2). The cradle 20 of the preferred embodiments preferably mechanically positions each of the plurality of cells 10 such that the axis of each of the plurality of cells is parallel to the axis of the channel 22. The cradle 20 preferably provides surfaces for the cradling of the plurality of cells 10 and the transferring of heat. When used with cylindrical cells, the surfaces are preferably radiused to provide a large surface area contact with the plurality of cells 10. In this variation, the surface area preferably extends at least one-third around the circumference of each cell 10 (and more preferably at least one-half around the circumference of each cell 10). However, any extension of the surface area around the circumference of each cell 10 suitable to heat exchange between the cradle 20 and each cell 10 may be used. If the invention is used with brick-shaped cells (similar to the cells used in conventional mobile phones), the surfaces are preferably flat. However, any other suitable geometry to mechanically position the cells may be used.

The plurality of cells 10 are preferably thermally managed by one of three preferred embodiments of the system 100. In a first preferred embodiment, the cradle 20 is preferably composed of more than one material and is preferably electrically insulated from the plurality of cells 10 and including electrical conductors to couple to the cells 10. In a second preferred embodiment, the cradle 20 is preferably composed of one material and is preferably electrically coupled with the plurality of cells 10. In both the first and second preferred embodiments, the cells 10 are preferably cradled in a triangular shape. In a third preferred embodiment, the cradle 20 preferably cradles the cells 10 in an ovular or rectangular shape and is otherwise similar to the cradle 20 of the second preferred embodiment such that the cradle 20 is preferably composed of one material and is electrically coupled with the plurality of cells 10. The heat conductor 30 and heat exchanger 40 of the preferred embodiments are preferably of variations that cooperate with the cradle 20 of the first, second, and third preferred embodiments to form a first, second, and third preferred embodiment of the system 100. The invention is preferably one of the three aforementioned preferred embodiments, but may alternatively be any combination of aforementioned embodiments, variations, or any method or system suitable to manage the cells of the system 100.

### 1 First Preferred Embodiment

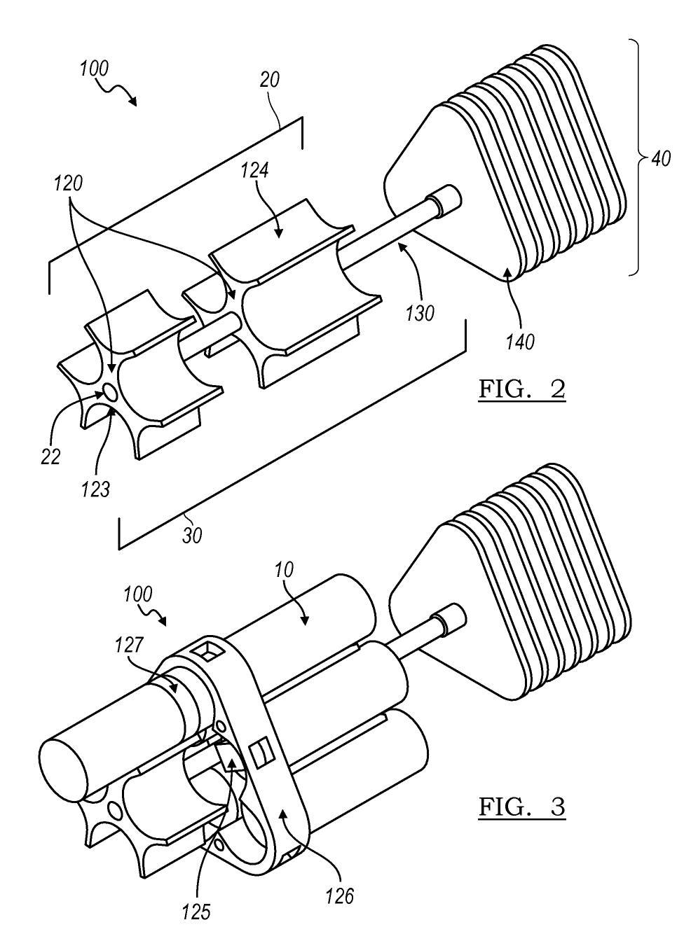

As shown in FIGS. 2-6, the system 100 of the first preferred embodiment includes a plurality of cells 10, a cradle 20 (which preferably includes three heat ductors 120), a heat conductor 30 (which preferably includes two heat pipes 130), and a heat exchanger 40 (which preferably includes two radiator-style heat exchangers 140). The system 100 of the first preferred embodiment may alternatively include one-half of the system (a plurality of cells 10, a cradle 20 that includes one and one-half heat ductors 120, a heat ductor 30 that includes one heat pipe 130, and a heat exchanger 40 that includes one radiator-style heat exchanger).

As shown in FIGS. 2 and 3, the heat ductor 120 of the first preferred embodiment functions to cradle the individual cells 10 and provide a stable structure to hold and maintain the plurality of cells 10 in a desired location and orientation, and also to transfer heat to and from the individual cells 10 to the heat pipe. In a first version, the heat ductor 120 is permanently or semi-permanently affixed to the heat pipe 130. In this version, the heat ductor 120 preferably includes a thermally conductive epoxy (such as produced and sold under the Artic Silver brand). The epoxy functions to fix the diameter of the heat pipe 130 to the channel 22 of the heat ductor 120, which provides both structural positioning and a heat pathway. The heat ductor 120 may alternatively be press-fit onto the heat pipe 130 or may be attached with any suitable method or device. In a second version, the heat ductor 120 is removably affixed to the heat pipe 130, which facilitates easy disassembly. In this version, the heat ductor 120 preferably defines a channel 22 with a diameter slightly greater than the diameter of the heat pipe 130, includes a sealing element at the openings of the central bore, and includes a heat conductive compound 123 (such as produced and sold under the Artic Silver brand). The conductive compound 123 functions to displace any air (which is a poor heat conductor) and forms a heat transfer connection between the heat pipe 130 and the heat ductor 120. The sealing element, which is preferably located on the heat ductor 120 but may be alternatively located on the heat pipe 130, functions to seal the conductive compound 123 surrounding the heat pipe 130 within the bore of the heat ductor 120. The sealing elements are preferably O-rings, but may alternatively be any suitable device. The heat ductor 120 is preferably made of aluminum (and is machined or extruded), but may alternatively be any suitable material.

In the first preferred embodiment, the heat ductor 120 also includes a thermally conductive electrical insulator 124 (such as a tape or coating) between the heat ductor 120 and the plurality of cells 10. The thermally conductive electrical insulator 124 functions to transfer heat from the plurality of cells 10 to the heat ductor 120, while electrically isolating the plurality of cells 10 and the heat ductor 120. The thermally conductive electrical insulator 124 is preferably a tape (such as T-Gard 210 brand), but may be a thin and/or flexible film (such as a plastic film), a coating, or any other suitable device or method that transfers heat from the plurality of cells 10 and electrically isolates the body of the cell. The thermally conductive electrical insulator 124 preferably covers the entire heat ductor 120 cutout, such that—when the cell is placed in this cutout—no metal part of the cell body contacts the metal of the heat ductor 120. The thermally conductive electrical insulator 124 preferably does not cover the ends of the cell, which provides location for electrical load path connection. The heat ductor 120 also preferably includes a fastener (such as cable ties, electrical tape, heat shrink tubing, etc.) to exert pressure (inward toward the heat ductor 120) on the plurality of cells 10, which maintains suitable thermal contact between cells and the thermally conductive electrical insulator.

The heat pipe 130 of the first preferred embodiment functions to transfer heat from the individual cells 10, through the heat ductor 120, and to the first heat exchanger 140. The heat pipe 130 is also capable of transferring heat from a heat source, through the heat ductor 120, and to the individual cells 10. The heat pipe 130 is preferably a sealed pipe 130 or tube made of a material with high thermal conductivity, such as copper or aluminum. Within the sealed cavity, the heat pipe 130 is nearly a vacuum with only a fraction of a percent by volume of a working fluid (or “coolant”), such as water, or ethanol. Due to the partial vacuum that is near or below the vapor pressure of the fluid, some of the fluid will be in the liquid phase and some will be in the gas phase. The heat pipe 130 may include an optional wick structure on the inside of the cavity walls. The wick structure, which functions to exert a capillary pressure on the liquid phase of the working fluid, may be a sintered metal powder or a series of grooves parallel to the axis of the heat pipe 130. The wick structure may alternatively be any material capable of exerting capillary pressure on the condensed liquid to wick it back to the heated end.

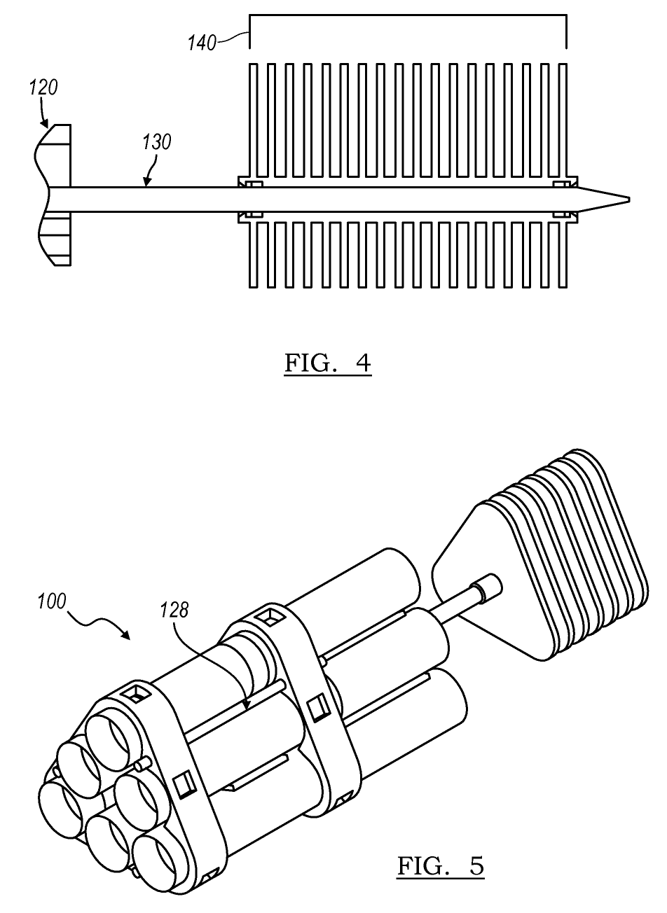

As shown in FIG. 4, the first heat exchanger 140 of the first preferred embodiment functions to dissipate the heat transferred from the cells by the heat pipe 130 through the heat ductor 120. The first heat exchanger 140 may alternatively function to transfer heat from a heat source to the heat pipe 130 and subsequently to the heat ductor 120 and the cells. In a first version, the first heat exchanger 140 is removably affixed to the heat pipe, which facilitates easy disassembly. In this version, the first heat exchanger 140 preferably defines a central bore slightly greater than the diameter of the heat pipe 130, includes a sealing element at the openings of the central bore, and includes a heat conductive compound (such as produced and sold under the Artic Silver brand). The conductive compound functions to displace any air (which is a poor heat conductor) and to form a heat transfer connection between the heat pipe 130 and the first heat exchanger 130. The sealing element, which is preferably located on the first heat exchanger 140 but may be alternatively located on the heat pipe 130, functions to seal the conductive compound surrounding the heat pipe 130 within the bore of the first heat exchanger 140. The sealing elements are preferably O-rings, but may alternatively be any suitable device. In a second version, the first heat exchanger 140 is semi-permanently or permanently affixed to the heat pipe 130 with an epoxy, through a press-fit connection, or by any suitable method or device. The first heat exchanger 140 is preferably a passive device, such as a thin fin heat sink that radiates heat through static and forced air convection. The first heat exchanger 140 may alternatively be an active device, such as a manifold that directs chilled liquid around the heat pipe 130 or across a cold plate that thermally attaches to the heat pipe. The first heat exchanger 140 may, however, be any suitable device that transfers heat to and/or from the plurality of cells and through the heat pipe 130 in any suitable heat transfer method.

The first heat exchanger 140 preferably exchanges heat with ambient air, but may alternatively be coupled to an external thermal management system that functions to regulate the temperature of the system 100 to a desired temperature level. The external thermal management system may include an device that actively removes heat from the first exchanger 140, for example, a refrigerant system, a Stirling cooler, a peltier cooler, or any other suitable cooling device. Alternatively, the external thermal management system may include a device that passively removes heat from the first exchanger 140, for example, when applied to motorcycle, the external thermal management system may include a geometry on the motorcycle that allows air to flow past the first heat exchanger 140 as the motorcycle is in motion. However, any suitable method or device to exchange heat with the first heat exchanger 140 may be used.

In the version that includes heat transferred to the plurality of cells, the external thermal management may include the heat source. The heat source functions to source heat to the battery cells in cold environments to create adequately warm operating conditions for the individual battery cells. In a first version, the heat source is in direct contact with the first heat exchanger 140, increasing the temperature of the first heat exchanger 140 to induce heat transfer through the heat pipe 130 to the individual battery cells. In a second version, the heat source is in direct contact with the heat pipes to induce heat transfer through the heat pipe 130 to the individual cells. The heat source may be a radiator, an additional heat exchanger that functions to exchange heat with a heat generating component of the device (such as the motor in a motorcycle), a heat storage device that stores heat generated by the device through a previous use cycle (for example, storage of heat generated by the plurality of cells in a prior use cycle), or any other suitable heat source.

As shown in FIG. 3, between each set of six cells, the first preferred embodiment also includes an electrical conductor 125, an electrical insulator substrate 126, and a flame-retardant shield 127. The electrical conductor 125 functions to connect cells in a series. The electrical insulator substrate 126 and the flame-retardant shield 127 cooperatively function to seal the plurality of cells 10 in an environmentally and electrically isolated confinement, which may improve the ability to contain heat and fire in the event of a cell catastrophic failure.

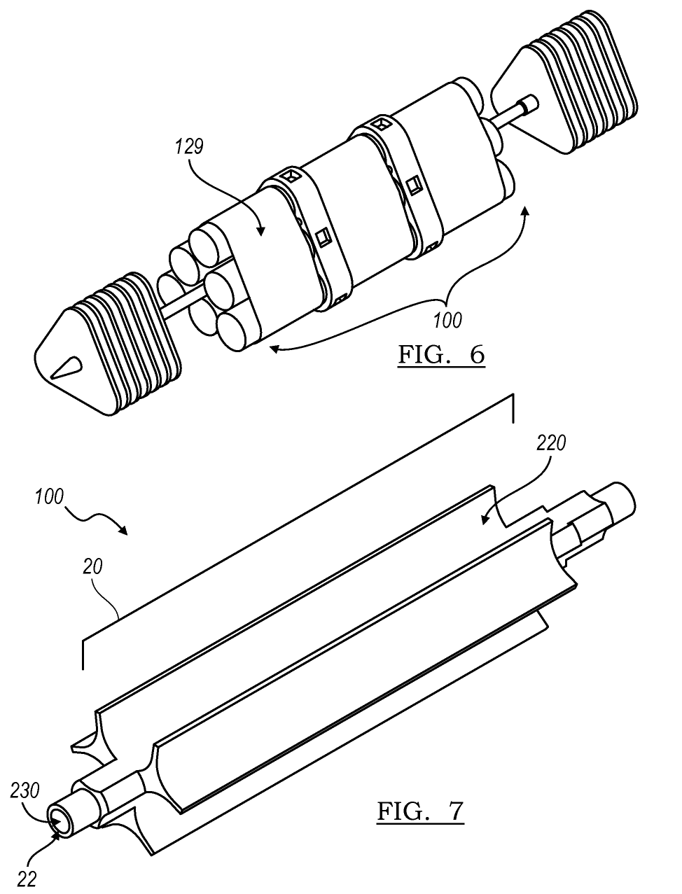

As shown in FIGS. 5 and 6, the system 100 of the first preferred embodiment includes three heat ductors 120, two heat pipes 130, and two first heat exchangers 140. The system 100 of the first preferred embodiment may also include short rod stand-offs 128 and a wrapping 129 around the perimeter of the plurality of cells 10. The short rod standoffs 128 function to pull the substrates toward each other, sandwiching cells in between and holding them in place, both physically and electrically. During manufacturing, two halves of the system 100 are preferably connected to each other through the use of the short rod standoffs 128. The wrapping functions to electrically insulate the raw cell bodies from adjoining cells, and to squeeze the plurality of cells 10 radially into pressurized contact with the heat ductor 120 for maximum heat transfer efficiency.

While the system 100 of the first preferred embodiment includes two heat pipes 130 that run approximately half of the length of the system 100, the system 100 may alternatively include just one heat pipe 130 that runs approximately the length of the system 100. Using one longer heat pipe, instead of two shorter heat pipes, is potentially more thermally efficient but potentially more difficult to source.

### 2. Second Preferred Embodiment

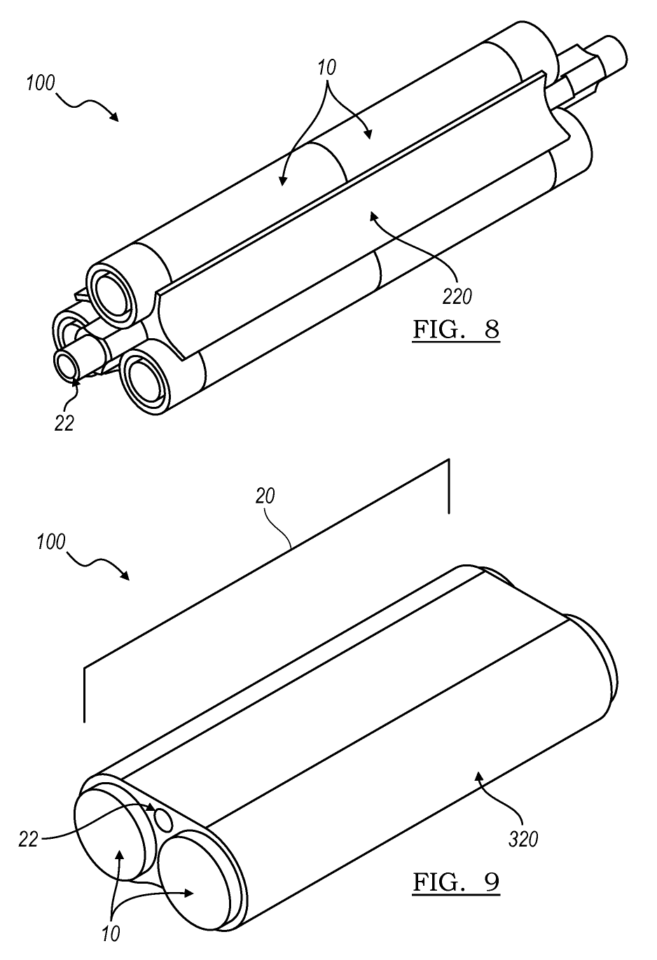

As shown in FIGS. 7 and 8, the system 100 of the second preferred embodiment includes a plurality of cells 10, a cradle 20 (which includes a ductor 220), a heat conductor 30 (which includes a fluid 230 that flows through the channel 22 of the ductor 220), and a heat exchanger (not shown). The heat exchanger of the second preferred embodiment is coupled to the fluid 230. The fluid 230 and the heat exchanger may also be coupled to an external thermal management system that functions to regulate the temperature of the system 100 to a desired temperature level. In all other respects, the elements of the second preferred embodiment are similar or identical to the elements of the first preferred embodiment.

The ductor 220 of the second preferred embodiment functions as the mechanical, thermal, and electrical connection for the plurality of cells 10. The ductor 220 is preferably made from a thermally and electrically conductive material, such as aluminum (and is preferably machined or extruded), but may alternatively be any suitable material. The ductor 220 preferably functions to cradle the cells 10 in a radial pattern and an axial orientation (relative to the fluid 230 flowing through the channel 22). The ductor 220 provides surfaces for the cradling of the cells and the transferring of heat. When used with cylindrical cells, the surfaces are preferably radiused to provide a large surface area contact with the cells. If the preferred embodiment is used with brick-shaped cells (similar to the cells used in conventional mobile phones), the surfaces are preferably flat.

The cells 10 of the second preferred embodiment directly contact the ductor 220 and, thus, are electrically connected to the ductor 220. In addition to the electrical connection of the ductor 220, the system 100 preferably includes at least one additional electrical conductor to complete the connection between the battery cells. The batteries are preferably arranged in a parallel type electrical connection. This arrangement enables the omission of the thermally conductive, electrically insulating tape, and the electrical insulator substrate in between cells 10 from the first preferred embodiment. The arrangement of cells 10 in the second preferred embodiment also accommodates for the variation in cell 10 diameter that is present in readily available battery cells on the market.

The fluid 230 of the second preferred embodiment functions to transfer heat from the individual cells 10 through the heat ductor 220 and to the heat exchanger. The fluid 230 may also function to transfer heat from an external heat source through the heat ductor 220 and to the individual cells 10. When adding heat to the ductor 220, heat from the heat source is transferred to the fluid 230 and is transferred to the cells 10 as the fluid 230 passes through the heat ductor 220. However, any other suitable arrangement of flow of the fluid 230 to thermally manage the plurality of cells 10 may be used. The fluid 230 of is preferably a working fluid selected based upon properties such as electrical resistivity, specific heat, thermal conductivity, viscosity, boiling and freezing points, and/or chemical stability in the environment of application (for example, the temperature range of the environment, exposure to different materials within the environment, etc). The fluid 230 is preferably water, propylene glycol, or a mixture of propylene glycol and water. The fluid 230 may alternatively be mineral oil, sunflower and canola oil, ethylene glycol, or a mixture of ethylene glycol and water, but may also be any other suitable working fluid 230. The second preferred embodiment may also include a pump that functions to drive the fluid 230. The pump is preferably capable of driving fluid 230 through the diameter of the channel 22 at a desired flow rate for the desired heat transfer.

The size of the channel 22 of the second preferred embodiment is preferably optimized for heat transfer relative to flow rate of the fluid 230 through the channel 22. The ductor 220 is preferably designed such that the fluid 230 is directed through the center of the ductor 220, allowing the fluid 230 to be equidistant to all cells upon passage through the ductor 220 and providing equal thermal management benefits to each cell. The ductor 220 may alternatively be designed to provide unequal thermal management benefits to the cells, which may be advantageous if the system includes a mixture of both “energy” and “power” cells that produce different amounts of heat and operate under different optimal thermal conditions. To increase thermal transfer, the ductor 220 is preferably made of aluminum or any other thermally conductive material. The channel 22 is preferably defined as a bore in the ductor 220. The channel 22 and other surfaces on the ductor 220 are preferably coated with a hard metal coating such as nickel or zinc that functions to allow small currents flow through the fluid 230 while protecting the ductor 220 from electroplating and other corrosion due to use and fluid 230 flow. Hard metal coating is high in conductivity and may be applied in a thin layer, having little or no detrimental effect on thermal transfer between the cells and the channel 22. Alternatively, the coating may be of a plastic or resin based coating that functions as a protective layer and a dielectric to prevent current from flowing in between neighboring ductors 220. Plastic or resin based coating is very effective in corrosion control, but may introduce resistance to thermal conductivity from the cells to the channel 22. The channel 22 may also be a pipe inserted into the ductor 220. The pipe is preferably made of hard metal to achieve similar corrosion prevention with little or no detrimental effect on thermal transfer as a hard metal coating. Alternatively, the pipe may be a plastic or resin based insert. However, any other suitable coating or pipe material may be used to protect the channel 22. The ductor 220 may alternatively have two channel 22S, allowing two flow paths to flow through the ductor 220 at one time. A ductor 220 with two channels 22 may also include a fluid turnaround element to direct the fluid 230 flowing through one channel 22 to turn around and flow through the second channel 22. This may facilitate the implementation of homogenous cooling to the system and be more space efficient.

In the variation wherein heat is transferred to the plurality of cells 10, the external thermal management may include the heat source. The heat source functions to source heat to the battery cells in cold environments to create adequately warm operating conditions for the individual battery cells. In a first version, the heat source is in direct contact with the second heat exchanger 240, increasing the temperature of the second heat exchanger to induce heat transfer through the fluid 230 to the individual battery cells. In a second version, the heat source is in direct contact with the fluid 230 to induce heat transfer through the fluid 230 to the individual cells 10. The heat source may be a radiator, an additional heat exchanger that functions to exchange heat with a heat generating component of the device (such as the motor in a motorcycle), a heat storage device that stores heat generated by the device through a previous use cycle (for example, storage of heat generated by the plurality of cells 10 in a prior use cycle), or any other suitable heat source.

The system 100 of the second preferred embodiment may also include a wrapping around the perimeter of the cells. The wrapping functions to electrically insulate the raw cell bodies from adjoining cells and to press the cells radially into substantially firm contact with the ductor 220, which preferably provides for maximum heat transfer efficiency and robust electrical connection.

The system 100 of the second preferred embodiment may also include electrical insulators and flame retardant shields that cooperatively function to seal the cells in an environmentally and electrically isolated confinement, which may improve the ability to contain heat and fire in the event of a cell catastrophic failure.

### 3 Third Preferred Embodiment

As shown in FIG. 9, the system 100 of the third preferred embodiment includes a plurality of cells 10, a cradle 20 (which includes a ductor 320), a heat conductor (not shown), and a heat exchanger (not shown). In all other respects, the elements of the third preferred embodiment are similar or identical to the elements of the second preferred embodiment.

The ductor 320 of the third preferred embodiment functions to mechanically position two cylindrical cells 10 at a radial distance from the channel 22 in a generally ovular or rectangular shape. The generally ovular or rectangular shape may facilitate the placement of relatively larger cells 10 in a compact manner to attain a power density substantially similar to the power density achieved when using the first and second preferred embodiments with relatively smaller cells 10. Alternatively, the ductor 320 may function to cradle four cells in a square shape or any other suitable number of cells in any suitable geometric shape. Like the cradle 20 of the second preferred embodiment, the ductor 320 of the third preferred embodiment is composed of one material that provides mechanical, thermal, and electrical connection to the plurality of cells 10. To increase the thermal connection between the cells 10 and the ductor 320, the ductor 320 preferably encloses the circumference of the cylindrical cell 10, but may alternatively provide a surface that extends at least one-half of the circumference of the cylindrical cell 10. By extending at least one-half of the circumference of the cylindrical cell 10, the ductor 320 also provides a mechanical coupling to the cell 10 and mechanically holds the cell 10 at the desired position. The ductor 320 may provide a surface that extends at least one-third of the circumference of the cylindrical cell 10, but may provide a surface that extends to any portion of the circumference of the cylindrical cell 10. The ductor 320 may alternatively function to hold non-cylindrical cells such as brick-shaped cells. The ductor 320 preferably mechanically positions the cells 10 radially equidistant from the channel 22, but may alternative position a first cell 10 at a first radial distance away from the channel 22 and a second cell 10 at a second radial distance away from the channel 22. This may better accommodate to different types of cells 10 that require different levels of thermal management that may be used within the system 100. However, any other suitable arrangement of the cells 10 relative to the channel 22 may be used.

### 4 Super Pack

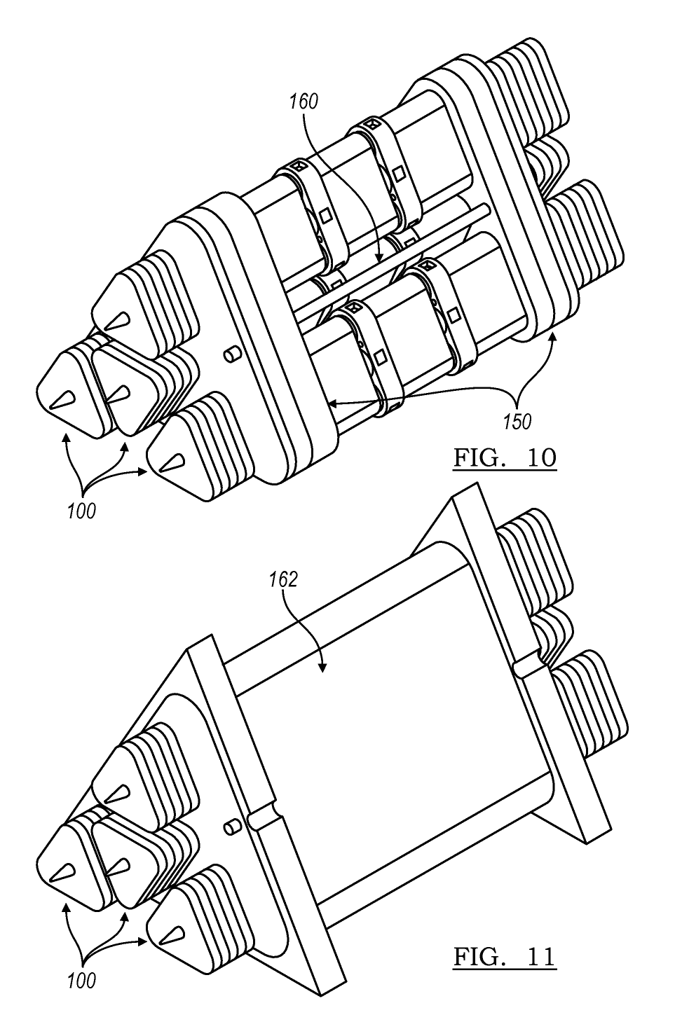

In application, the system 100 may be paired with a plurality of other systems 100 to form a super pack. The super pack may then be used as a larger magnitude power source for a device that utilizes portable power. As shown in FIGS. 10-14, the plurality of systems 100 may be arranged in a variety of orientations within the pack. The arrangement of the plurality of systems 100 is preferably one of three variations. Each variation is preferably used with one of the preferred embodiments of the system 100, but may alternatively be used with any suitable combination of preferred embodiments of the system 100.

As shown in FIGS. 10-11, the super pack of the first variation preferably includes four systems 100 of the first preferred embodiment for a grand total of seventy-two cells in a pack. To integrate the four systems 100, the super pack also includes two endcaps 150 and long rod stand-offs 160. The endcaps 150 function to align and mechanically hold each of the four systems in place relative to each other. The endcaps 150 also function to support the heat exchanger 40. The endcaps 150 may also function to provide a physical and thermal separation between the heat exchanger 40 and the cells 10. The long rod standoffs function to pull the end caps toward each other, holding the systems in place. The first variation also includes a casing 162 around the perimeter of the systems. The casing functions as a seal 164, to provide a closed environment and keep out contamination.

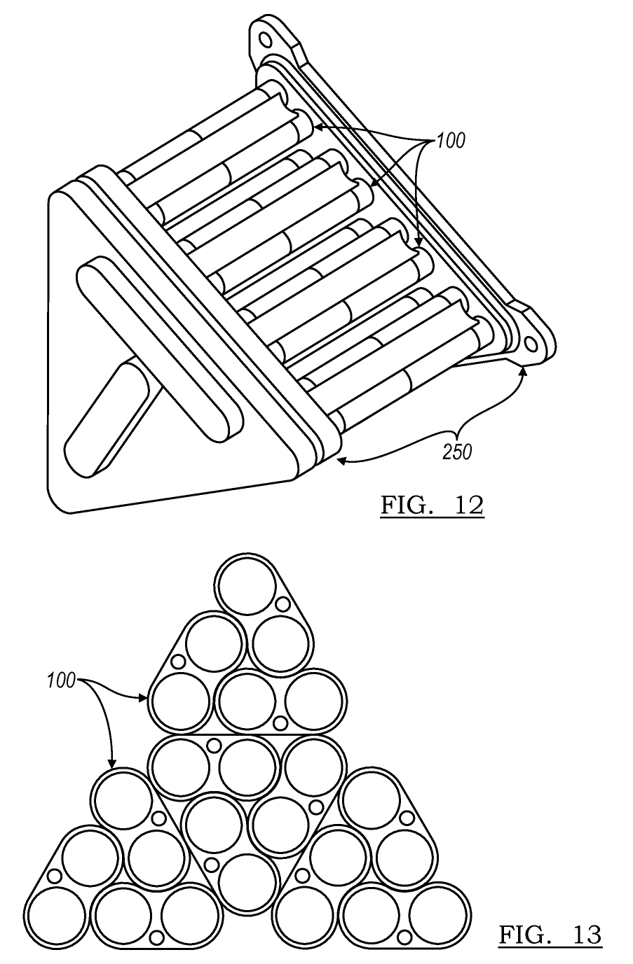

As shown in FIG. 12, the super pack of the second variation preferably includes sixteen systems 100 of the second preferred embodiment for a grand total of ninety-six cells. To integrate the sixteen systems, the super pack also includes two endcaps 250. The endcaps 250 function to align and mechanically hold each of the sixteen systems 100 in place relative to each other. The endcaps 250 preferably function to arrange the system 100 into a tessellating arrangement, allowing the super pack to remain compact and relatively small in volume. In all other respects, the super pack of the third variation is preferably similar to or identical to that of the second variation.

As shown in FIG. 13, the super pack of the third variation includes twelve systems 100 of the third preferred embodiment arranged in a tessellating pattern. In all other respects, the super pack of the third variation is preferably similar to or identical to that of the second variation.

As a person skilled in the art will recognize from the previous detailed description and from the figures and claims, modifications and changes can be made to the preferred embodiments of the invention (including, for example, all suitable combination and permutations of the variations and versions described above) without departing from the scope of this invention defined in the following claims.

We claim:

1. A multi-cell battery pack system with integrated thermal management, comprising:
a plurality of cylindrical cells having a rounded side surface and two opposing end surfaces;
a cradle having an internal surface that defines a channel that extends through the length of the cradle and having an external surface that mechanically positions each of the cells radially around and parallel to the channel and that exchanges heat with the cells by extending about the rounded surface in a circumferential direction and substantially extending between the two opposing end surfaces in an axial direction;
a heat conductor that resides at least partially within the channel and exchanges heat with the interior surface of the cradle; and
a heat exchanger that exchanges heat with the heat conductor; wherein the cradle, the heat conductor, and the heat exchanger cooperate to exchange heat between the cells and the heat exchanger.

2. The system of claim 1, wherein the cradle positions the cells radially equidistant from the heat conductor.

3. The system of claim 1, wherein the external surface of the cradle extends at least one-third about the rounded surface in a circumferential direction.

4. The system of claim 1, wherein the heat conductor is thermally coupled to the entire interior surface of the cradle.

5. The system of claim 1, wherein the cradle also electrically couples with each of the cells.

6. The system of claim 1, wherein the cells are lithium ion cells.

7. The system of claim 6, wherein the cells are selected from the group of lithium ion cells consisting of: type 18650 and type 26700.

8. The system of claim 1, wherein the cradle further includes a thermally conductive compound that facilitates the heat exchange between the cradle and the heat conductor.

9. The system of claim 8, wherein the cradle further includes a second conductive compound that facilitates the heat exchange between the cells and the cradle.

10. The system of claim 9, wherein the second conductive compound electrically insulates the cells from the cradle.

11. The system of claim 1, wherein the cradle includes an electrical insulator to electrically insulate the cells from the cradle.

12. The system of claim 1, wherein the cradle is composed of one uniform material that allows the cradle to mechanically, thermally, and electrically couple to the cells.

13. The system of claim 12, wherein the cradle is composed of aluminum.

14. The system of claim 1, wherein the cradle mechanically couples the cells into a triangular shape.

15. The system of claim 1, wherein the heat conductor includes a fluid that flows through the channel of the cradle and to the heat exchanger, wherein the fluid transfers heat between the cradle and the heat exchanger.

16. The system of claim 15, wherein the heat conductor further includes a sealed tube that contains the fluid, wherein the tube is mounted to the channel and the heat exchanger, and wherein the tube is composed of a conductive material.

17. The system of claim 16, wherein the fluid changes phase during the flow between the cradle and the heat exchanger.

18. The system of claim 15, wherein the fluid is selected from the group consisting of: air, water, ethanol, and propylene glycol.

19. The system of claim 15, wherein the system further includes a second cradle substantially identical to the cradle and the fluid transfers heat between the cradle, the second cradle, and the heat exchanger.

20. The system of claim 19, wherein the fluid flows through the channel of the cradle to the channel of the second cradle, through the channel of the second cradle to the heat exchanger, and from the heat exchanger to the channel of the cradle.

21. The system of claim 19, wherein the fluid includes a first portion and a second portion and the system further includes a second heat exchanger, wherein the first portion of the fluid flows from the cradle to the heat exchanger and from the heat exchanger to the cradle and the second portion of the fluid flows from the second cradle to the second heat exchanger and from the second heat exchanger to the second cradle.

22. The system of claim 1, wherein the heat conductor includes a conductive material that transfers heat between the cradle and the heat exchanger, the material selected from the group consisting of: aluminum and copper.

23. The system of claim 1, wherein the heat conductor transfers heat from the cradle to the heat exchanger.

24. The system of claim 1, wherein the heat conductor transfers heat from the heat exchanger to the cradle.

25. The system of claim 1, wherein the heat exchanger exchanges heat with a second fluid selected from the group consisting of: cooled air, heated air, water, ethanol, sodium, and propylene glycol.

26. The system of claim 1, wherein the heat exchanger exchanges heat with ambient air.

27. The system of claim 1, wherein the heat exchanger includes fins that increase the surface area for heat exchange.

28. A method for thermal management of a multi-cell battery pack comprising the steps of:
providing a fluid that transfers heat;
positioning a plurality of cells radially around the fluid;
providing a heat exchanger;
facilitating heat exchange between the plurality of cells and the fluid;
facilitating the fluid to travel to the heat exchanger; and
facilitating heat exchange between the fluid and the heat exchanger.

29. The method of claim 28, wherein the cells are positioned radially equidistant from the fluid.

30. The method of claim 28, wherein heat is transferred from the cells to the heat exchanger.

31. The method of claim 28, wherein heat is transferred from the heat exchanger to the cells.

32. The method of claim 28, further comprising providing a cradle that mechanically and thermally couples to the cells and wherein allowing heat exchange between the plurality of cells and the fluid includes the steps of allowing heat exchange between the cells and the cradle and allowing heat exchange between the cradle and the fluid.
